(19) United States
(12) Patent Application Publication
(10) Pub. No.: US 2025/0055536 A1
(43) Pub. Date: Feb. 13, 2025

(54) ENHANCED CSI REPORTING FRAMEWORK

(71) Applicant: Nokia Technologies Oy, Espoo (FI)

(72) Inventors: Matha DEGHEL, Massy (FR); Filippo TOSATO, Massy (FR)

(21) Appl. No.: 18/791,365

(22) Filed: Jul. 31, 2024

Related U.S. Application Data
(60) Provisional application No. 63/531,179, filed on Aug. 7, 2023.

(51) Int. Cl. H04B 7/06; H04B 7/0456

(52) U.S. Cl. CPC H04B 7/0626; H04B 7/0456

(57) ABSTRACT

An apparatus configured to: determine whether CSI of at least one first sub-configuration of a CSI report configuration and CSI of at least one second sub-configuration of the CSI report configuration are associated to a CSI-RS resource; determine to transmit at least one indicator in the CSI of the at least one first sub-configuration, in response to the CSI of the at least one first sub-configuration and the CSI of the at least one second sub-configuration being associated to the CSI-RS resource; and determine to not transmit at least one indicator in the CSI of the at least one second sub-configuration, in response to the CSI of the at least one first sub-configuration and the CSI of the at least one second sub-configuration being associated to the CSI-RS resource.

### TECHNICAL FIELD

The examples and non-limiting example embodiments relate generally to communications and, more particularly, to an enhanced CSI reporting framework.

### BACKGROUND

It is known perform measurement of a communication channel in a communication network.

### BRIEF DESCRIPTION OF THE DRAWINGS

The foregoing aspects and other features are explained in the following description, taken in connection with the accompanying drawings.

FIG. 1 shows an example illustrating aspects of the examples described herein.

FIG. 2 shows an example illustrating aspects of the examples described herein.

FIG. 3 shows an example illustrating aspects of the examples described herein.

FIG. 4 shows an example illustrating aspects of the examples described herein.

FIG. 5 is a block diagram of one possible and non-limiting system in which the example embodiments may be practiced.

FIG. 6 is an example apparatus configured to implement the examples described herein.

FIG. 7 shows a representation of an example of non-volatile memory media used to store instructions that implement the examples described herein.

FIG. 8 is an example method, based on the examples described herein.

FIG. 9 is an example method, based on the examples described herein.

### DETAILED DESCRIPTION OF EXAMPLE EMBODIMENTS

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g. XR), networks are being denser, use more antennas, larger bandwidths and more frequency bands. The environmental impact of 5G needs to stay under control, and novel solutions to improve network energy savings need to be developed.

Energy consumption has become a key part of the operators' OPEX. According to a report from GSMA, the energy cost on mobile networks accounts for ˜23% of the total operator cost. Most of the energy consumption comes from the radio access network and in particular from the Active Antenna Unit (AAU), with data centres and fibre transport accounting for a smaller share. The power consumption of a radio access can be split into two parts: the dynamic part which is only consumed when data transmission/reception is ongoing, and the static part which is consumed all the time to maintain the necessary operation of the radio access devices, even when the data transmission/reception is not on-going.

CSI-RS reference signals are UE-specifically configured in RRC. However, CSI-RS reference signals can be shared among many UEs, i.e., more than 1 UE are configured to receive the same resource elements (RE).

In general, in order to save on DL resources, the gNB would try to use cell-specific or group-specific CSI-RS resources. The worst case of DL overhead is with UE specific CSI-RS where the DL overhead increases linearly with the number of UEs in the cell.

CSI-RS has many functions in NR, e.g.: CSI-RS for DL CSI acquisition, CSI-RS for beam management (BM) (based on L1-RSRP), CSI-RS for tracking (TRS), and UL CSI acquisition in reciprocity-based UL precoding.

In some applications (e.g., CSI-RS for BM) CSI-RS are spatially beamformed into different directions.

In general, a UE can be configured with up to 48 report configurations per component carrier (CC)/4 per bandwidth part (BWP).

One CSI resource config within 1 report config can be configured with up to 16 resource sets (aperiodic CSI) and 1 resource set (otherwise).

In each CSI resource set up to 64 NZP CSI-RS resources and 1 NZP-CSI-RS resource up to 32 antenna ports.

For CSI acquisition, the UE is configured also with a codebook type. Given the measured channel across a CSI-RS resource, the UE can choose a favourite codeword from the specified codebook, i.e., precoding matrix indicator (PMI), along with channel quality indicator (CQI), rank indicator (RI). UE can also be configured to measure several CSI-RS resources (up to 8) within a resource set and report the favourite resource, CSI-RS resource indicator (CRI), along with PMI, CQI and RI which corresponds to that selected resource.

Time domain: In the time domain, a CSI-RS resource may start at any OFDM symbol of a slot and it spans 1, 2, or 4 OFDM symbols depending on the number of ports configured.

Likewise, also the UE measurement reporting of CSI can be also operated with periodic, semi-persistent, or aperiodic manner, which is so-called report types in NR report configuration. However, there are certain limitations, based on which the UE periodic report can operate only based on the configured periodic CSI-RS resource-set, the UE semi-persistent report can operate based on both configured periodic and semi-persistent CSI-RS resource-set, and finally the UE aperiodic report can operate based on all periodic, semi-persistent, and aperiodic CSI-RS resource-set. Shortly said: the periodic CSI-RS resources can be used to generate any report type, the semi-persistent and periodic CSI-RS resources can be used to generate semi-persistent CSI reports, and the aperiodic CSI-RS can only be utilized only to generate the aperiodic report.

All CSI-RS resources within one set are configured with same density and same nrofPorts, except for the NZP CSI-RS resources used for interference measurement.

For semi-persistent and aperiodic CSI-RS, the actual triggering of CSI-RS transmission is per CSI-RS resource-set via either MAC CE or DCI. And a resource set can be used as part of UE report configurations describing what to be measured and, correspondingly, which measurement reporting are to be done by the UE. Specifically, if a CSI-RS resource-set is configured as ‘aperiodic’ by RRC, the CSI-RS resource set configuration includes a slot offset, aperiodicTriggeringOffset which defines the time interval between the triggering DCI and the CSI-RS transmission.

For A-CSI reporting up to 16 different reporting settings can be triggered with single DCI (e.g. for multiple component carriers) while SP-CSI reporting can trigger only one report setting with a single DCI. In order to trigger several SP-CSI reports (each in different slots), multiple DCIs are needed.

CSI report content: For Type I and Type II CSI feedback on PUSCH, a CSI report comprises of two parts. Part 1 has a fixed payload size and is used to identify the number of information bits in Part 2. Part 1 shall be transmitted in its entirety before Part 2. For Type I CSI feedback, Part 1 contains RI (if reported), CRI (if reported), CQI for the first codeword. Part 2 contains PMI (if reported), LI (if reported), and contains the CQI for the second codeword when RI (if reported) is larger than 4. For Type II CSI feedback, Part 1 contains RI (if reported), CQI, and an indication of the number of non-zero wideband amplitude coefficients per layer for the Type II CSI (see sub-clause 5.2.2). The fields of Part 1-RI (if reported), CQI, and the indication of the number of non-zero wideband amplitude coefficients for each layer—are separately encoded. Part 2 contains the PMI of the Type II CSI. Part 1 and 2 are separately encoded.

Note that the precoder matrices W in Type-I and Rel-15 Type-II codebooks can be described as being decomposed into two matrix factors which are each matrix factor such that W(i1, i2)=W1(i1) W2(i2), where W1 is precoder matrix targeting the long-term channel which is selected on a wide-band basis while W2 targets the short-term/frequency-selective properties of the channel and can be reported on a per sub-band basis.

CSI computation: The UE shall calculate CSI parameters (if reported) assuming the following dependencies between CSI parameters (if reported). PMI shall be calculated conditioned on the reported RI and CRI. RI shall be calculated conditioned on the reported CRI.

The approved Rel-18 WID (working item description) includes an indication to specify necessary enhancements on CSI and beam management related procedures including measurement and report, and signaling to enable efficient adaptation of spatial elements (e.g. antenna ports, active transceiver chains) and power adaptation.

Main considerations and intentions of Rel-18 work include adaptation of spatial pattern for DL transmissions by (dynamically) muting/unmuting spatial elements, enhanced CSI feedback from the UE accounting for different spatial patterns to assist the network in making appropriate decision regarding the adaptations, and that the gNB may indicate a spatial pattern change so that the UE adapts the reception accordingly (support pending in RAN1). Similar considerations are there for power domain adaptation.

As noted previously, (dynamic) spatial domain adaptation and power domain adaptation will be specified in Rel-18 NR. CSI enhancements will be specified wherein a UE may calculate and report multiple CSIs corresponding to different spatial (adaptation) patterns and/or power control offsets. This is to enable the gNB to make appropriate decision regarding spatial adaptation and power adaptation.

The focus of the herein described examples is mainly on the aspect of CSI(s) report content (and CSI calculation) for CSIs used to enable spatial adaptation and/or power adaptation. Specifically, at least for Type 2 Spatial domain adaptation and for power domain adaptation (and potentially also for Type 1 Spatial domain adaptation), the focus is mainly on conditions (or rules) and enhanced operations under which some CSI(s) content could be reduced without any performance degradation or with little performance impact. This would then clearly result in reduced UL/CSI overhead.

In the herein described solution, given a CSI report configuration that includes or is associated with multiple sub-configurations (where sub-configuration may include or be associated to one or more CSI-RS resources).

If at least two CSIs, corresponding to at least two sub-configurations, are associated to the same CSI-RS resource either by selected CRI (CSI-RS resource indicator) or by configuration, only one PMI (precoding matrix indicator) is reported. Specifically, for such at least two sub-configurations, the UE reports the PMI only in the CSI (content) of one of these sub-configurations, i.e., the UE omits the PMI from the CSIs (content) of the other sub-configurations (of the at least two sub-configurations); such omitting for a sub-configuration may then result in omitting all part 2 CSI in some cases.

In an example, even though two or more CSI-RS resources respectively associated to two or more sub-configurations may be different, the two or more CSI-RS resources may be determined to be or be treated as the same CSI-RS resource; for example, when the two or more CSI-RS resources are linked by configuration and/or by CRI selection. In this example, the UE 10 determines to report a respective indicator from channel state information of one or more of the two or more sub-configurations, and determines to not report a respective indicator from channel state information of one or more of the two or more sub-configurations.

The UE 10 determines the one sub-configuration for which the CSI should contain the PMI based on one or more of the following (1-2):
1. The UE may be specified or configured/indicated (e.g., via RRC) to report the PMI only in the CSI of the sub-configuration with the lowest/highest index or in the first sub-configuration among the at least two sub-configurations. This may be applicable if the rank indicator is the same for the at least two sub-configurations. The above approach may also additionally or alternatively be used/adopted for reporting LI (layer indicator, which indicates which columns of the PMI corresponds to the strongest layer). Specifically, the UE would report the LI only in the CSI of the sub-configuration with the lowest/highest index or in the first sub-configuration.
2. The UE may be specified or configured/indicated (e.g., via RRC) to report the PMI only in the CSI of the sub-configuration with the highest rank indicator among the at least two sub-configurations. This may be applicable if the rank indicator is different for some or all of the at least two sub-configurations. The above approach may also additionally or alternatively be used/adopted for reporting LI. Specifically, the UE would report the LI only in the CSI of the sub-configuration with the highest rank indicator among the at least two sub-configurations.

In an embodiment, only the PMI wideband (WB) part (W1) is shared between the CSIs of the at least two sub-configurations, and thus the PMI sub-band (SB) part(s) (W2) is different. Specifically, for the at least two sub-configurations, the UE reports the PMI wideband part (W1) only in the CSI (content) of one of these sub-configurations, i.e., the UE omits PMI wideband part (W1) from the CSIs (content) of the other sub-configurations (of the at least two sub-configurations). Similar to above, the UE may be specified or configured/indicated (e.g., via RRC) to report the PMI wideband part only in the CSI of the sub-configuration with the highest rank indicator. This may be applicable if the rank indicator is different for some or all of the at least two sub-configurations.

Some or all of the multiple sub-configurations may have a same number of antenna ports. More generally, these sub-configurations may share other elements/parameters in the CSI report configuration, such as antenna port layout in a vertical dimension (N1), antenna port layout in a horizontal dimension (N2), number of antenna panels at the gNB side (Ng), etc. Some or all of the multiple sub-configurations may correspond to different power control offset values. Some or all of the multiple sub-configurations may not include a certain parameter such as a port subset indication.

Some or all of the multiple sub-configurations may correspond to or enable Type 2 spatial domain adaptation and/or power domain adaptation. Alternatively, or additionally, some or all of the multiple sub-configurations may correspond to or enable Type 1 spatial domain adaptation.

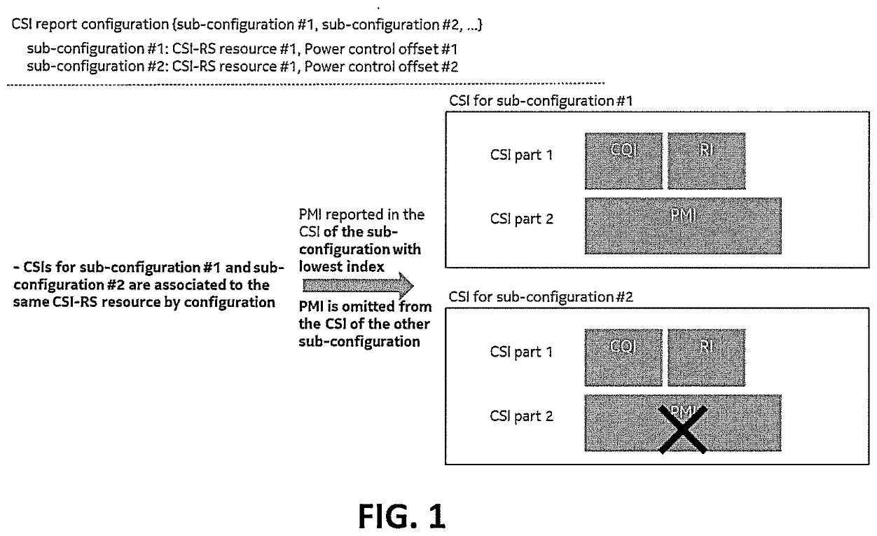

In FIG. 1, the CSI report configuration comprises a set of sub-configurations, where the set includes at least sub-configuration #1 having an index of 1 and sub-configuration #2 having an index of 2 (the index in an example indicates the position in the set). Sub-configuration #1 is associated to CSI-RS resource #1 and power control offset #1. Sub-configuration #2 is associated to CSI-RS resource #1 and power control offset #2. CSIs for sub-configuration #1 and sub-configuration #2 are associated to the same CSI-RS resource (namely CSI-RS resource #1) by configuration. The PMI is reported in the CSI of the sub-configuration with the lowest index, namely sub-configuration #1, and the PMI is omitted from the CSI of the other sub-configuration, namely sub-configuration #2.

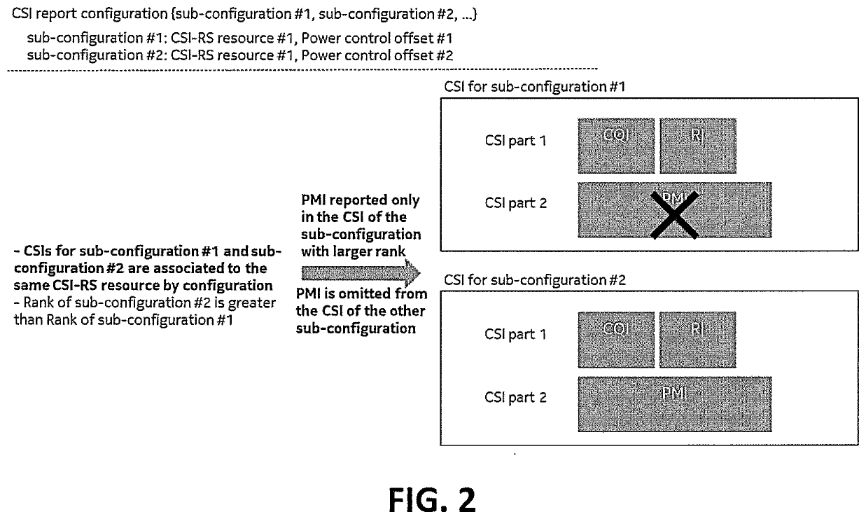

In FIG. 2, the CSI report configuration comprises a set of sub-configurations, where the set includes at least sub-configuration #1 and sub-configuration #2. Sub-configuration #1 is associated to CSI-RS resource #1 and power control offset #1. Sub-configuration #2 is associated to CSI-RS resource #1 and power control offset #2. CSIs for sub-configuration #1 and sub-configuration #2 are associated to the same CSI-RS resource (namely CSI-RS resource #1) by configuration. The rank of sub-configuration #2 is greater than the rank of sub-configuration #1. The PMI is reported only in the CSI of the sub-configuration with larger rank, namely sub-configuration #2. The PMI is omitted from the CSI of the other sub-configuration with the lower rank, namely sub-configuration #1.

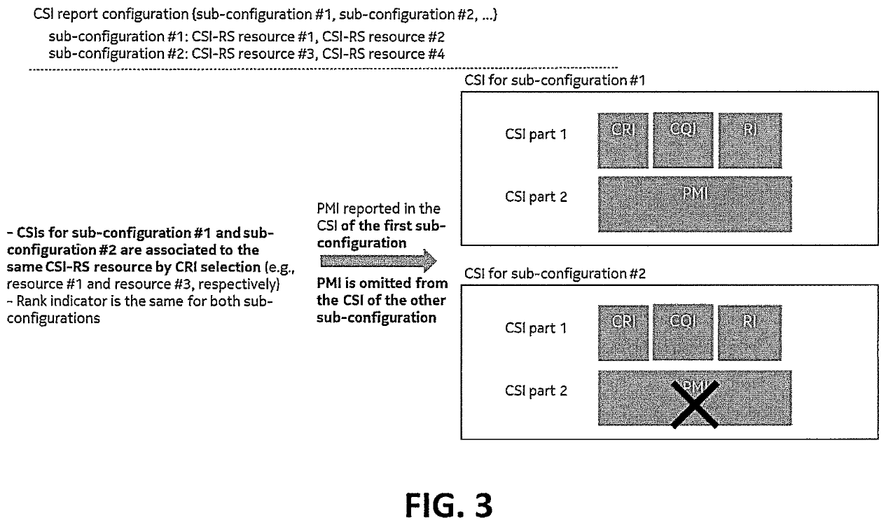

In FIG. 3, the CSI report configuration comprises a set of sub-configurations, where the set includes at least sub-configuration #1 and sub-configuration #2. Sub-configuration #1 is associated to CSI-RS resource #1 and CSI-RS resource #2. Sub-configuration #2 is associated to CSI-RS resource #3 and CSI-RS resource #4. CSIs for sub-configuration #1 and sub-configuration #2 are associated to the same CSI-RS resource by CRI selection (e.g., resource #1 and resource #3, respectively); association to the same CSI-RS resource may be assumed here since the selected CRI (e.g., CRI=1) is the same for the CSIs of the two sub-configurations. The rank indicator is the same for both sub-configurations. The PMI is reported in the CSI of the first sub-configuration, namely sub-configuration #1, and the PMI is omitted from the CSI of the other sub-configuration, namely sub-configuration #2.

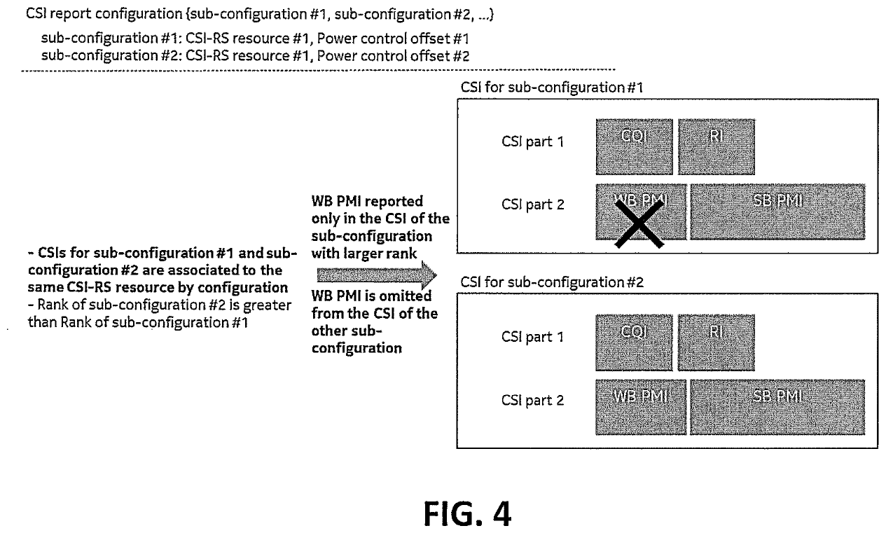

In FIG. 4, the CSI report configuration comprises a set of sub-configurations, where the set includes at least sub-configuration #1 and sub-configuration #2. Sub-configuration #1 is associated to CSI-RS resource #1 and power control offset #1. Sub-configuration #2 is associated to CSI-RS resource #1 and power control offset #2. CSIs for sub-configuration #1 and sub-configuration #2 are associated to the same CSI-RS resource by configuration. The rank of sub-configuration #2 is greater than the rank of sub-configuration #1. WB PMI is reported only in the CSI of the sub-configuration with the larger rank, namely sub-configuration #2. WB PMI is omitted from the CSI of the sub-configuration with the lower rank, namely sub-configuration #1. WB and SB refer to wideband and sub-band, respectively.

In an embodiment, channel state information of at least one first sub-configuration and channel state information of at least one second sub-configuration may be determined to be associated to the same channel state information reference signal resource based on at least one of: a channel state information reference signal resource for the at least one first sub-configuration being linked to a channel state information reference signal resource for the at least one second sub-configuration, or a channel state information reference signal resource for the at least one first sub-configuration being linked to a channel state information reference signal resource for the at least one second sub-configuration, and at least one or a selected channel state information reference signal resource indicator for the channel state information of the at least one first sub-configuration and for the channel state information of the at least one second sub-configuration points to the channel state information reference signal resource for the at least one first sub-configuration and the channel state information reference signal resource for the at least one second sub-configuration, respectively, or a selected channel state information reference signal resource indicator for the channel state information of the at least one first sub-configuration being the same as a selected channel state information reference signal resource indicator for the channel state information of the at least one second sub-configuration.

In an example, if a sub-configuration is associated to two or more CSI-RS resources, it is expected that the UE 10 would select one of these resources. CRI would then indicate the selected resource, and it would be determined (e.g. by UE 10) that channel state information of at least one first sub-configuration and channel state information of at least one second sub-configuration are associated to the same channel state information reference signal resource.

In an embodiment, the at least one first sub-configuration and the at least one second sub-configuration share a same parameter, where an example parameter is a number of antenna ports, N1, N2, etc.

In an embodiment, the at least one first sub-configuration and the at least one second sub-configuration correspond to a same domain adaptation, where example same domain adaptations include a spatial adaptation, or a power adaptation, or a Type 2 spatial domain adaptation etc.

In an embodiment, the at least one first sub-configuration and the at least one second sub-configuration do not comprise or contain a certain parameter, where an example parameter in this embodiment is a port subset indicator.

In an embodiment, the at least one first sub-configuration and the at least one second sub-configuration have a special configuration element or belong to a group of sub-configurations, where the special element is an element indication that the herein described operation(s) could be applied for the corresponding sub-configuration.

In some embodiments, at least one indicator in the channel state information of the sub-configurations may be one or more of: PMI, wideband PMI, layer indicator, channel quality indicator, CSI-RS resource indicator.

For report quantities including CRI, if a sub-configuration includes or is associated with more than one CSI-RS resource (for channel measurements), then CRI selection and thus reporting is needed for that sub-configuration. Otherwise, if a sub-configuration includes or is associated with a single CSI-RS resource, then CRI reporting is not needed for that sub-configuration.

In some embodiments, each of the multiple sub-configurations, in the CSI report configuration, may correspond to or be associated to or be replaced by at least one of the following: 1) a spatial (adaptation) pattern-different patterns have different sub-set/set (or number) of active/muted spatial elements, (such as antenna ports, antenna elements, etc.), or 2) an antenna port subset, or 3) a power level, such as correspondent to power control offset, or 4) a CSI-RS resource, or 5) a CSI-RS resource set or group, or 6) a codebook configuration, or 7) a frequency report configuration or sub-band configuration.

Advantages and technical effects of the examples described herein include Reduced UL/CSI overhead, mainly in terms of PMI reporting (but also LI reporting, CQI reporting, CRI reporting) for some sub-configurations and under certain conditions, and reduced CSI computation complexity under certain conditions. These reductions could be achieved without any performance degradation at least in some cases and with little performance impact (if any) in some other cases.

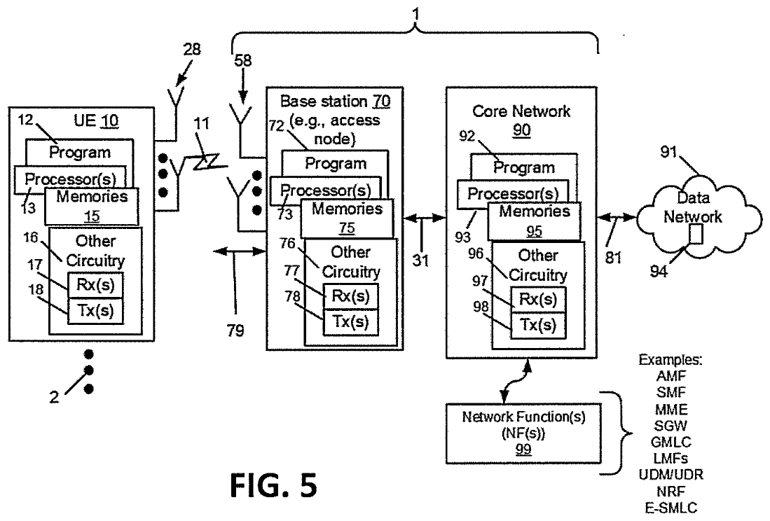

FIG. 5 shows a block diagram of one possible and non-limiting example of a cellular network 1 that is connected to a user equipment (UE) 10. A number of network elements are shown in the cellular network of FIG. 5: a base station 70; and a core network 90.

In FIG. 5, a user equipment (UE) 10 is in wireless communication via radio link 11 with the base station 70 of the cellular network 1. A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the base station 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The base station 70, as a network element of the cellular network 1, provides the UE 10 access to cellular network 1 and to the data network 91 via the core network 90 (e.g., via a user plane function (UPF) of the core network 90). The base station 70 is illustrated as having one or more antennas 58. In general, the base station 70 is referred to as RAN node 70 herein. An example of a RAN node 70 is a gNB. There are, however, many other examples of RAN nodes including an eNB (LTE base station) or transmission reception point (TRP). The base station 70 includes one or more processors 73, one or more memories 75, and other circuitry 76. The other circuitry 76 includes one or more receivers (Rx(s)) 77 and one or more transmitters (Tx(s)) 78. A program 72 is used to cause the base station 70 to perform the operations described herein.

It is noted that the base station 70 may instead be implemented via other wireless technologies, such as Wi-Fi (a wireless networking protocol that devices use to communicate without direct cable connections). In the case of Wi-Fi, the link 11 could be characterized as a wireless link.

Two or more base stations 70 communicate using, e.g., link(s) 79. The link(s) 79 may be wired or wireless or both and may implement, e.g., an Xn interface for fifth generation (5G), an X2 interface for LTE, or other suitable interface for other standards.

The cellular network 1 may include a core network 90, as a third illustrated element or elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple network functions (NF(s)) 99, and the program 92 may comprise one or more of the NFs 99. A 5G core network may use hardware such as memory and processors and a virtualization layer. It could be a single standalone computing system, a distributed computing system, or a cloud computing system. The NFs 99, as network elements, of the core network could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE network may be provided by an MME (Mobility Management Entity) and/or SGW (Serving Gateway) functionality, which routes data to the data network. Many others are possible, as illustrated by the examples in FIG. 5: AMF; SMF; MME; SGW; gateway mobile location center (GMLC); location management functions (LMFs); unified data management (UDM); unified data repository (UDR); network repository function (NRF); and/or evolved serving mobile location center (E-SMLC). These are merely exemplary core network functionality that may be provided by the core network 90, and note that both 5G and LTE core network functionality might be provided by the core network 90. The radio access network (RAN) node 70 is coupled via a backhaul link 31 to the core network 90. The RAN node 70 and the core network 90 may include an NG interface for 5G, or an S1 interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, base station 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

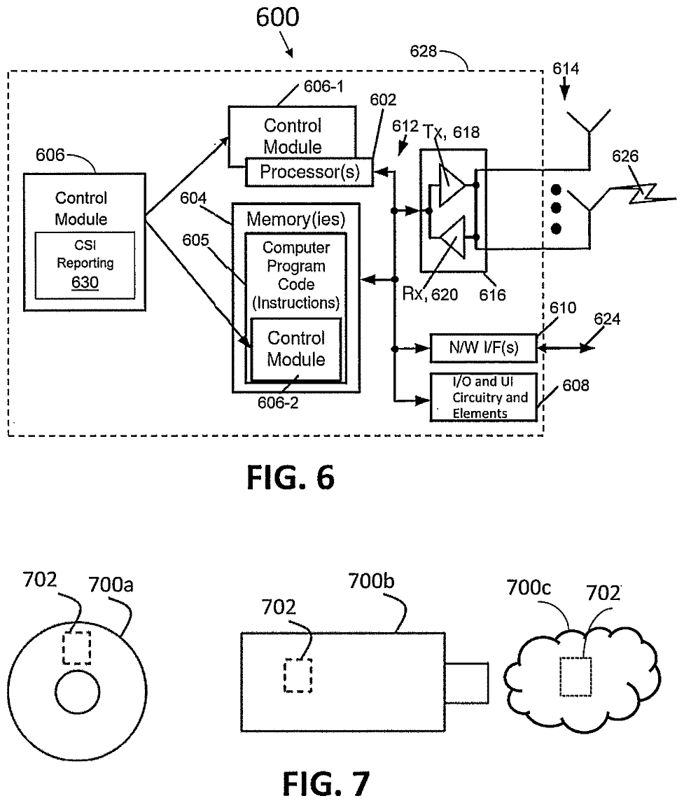

FIG. 6 shows an example apparatus 600, which may be implemented in hardware, configured to implement the examples described herein. The apparatus 600 comprises at least one processor 602 (e.g. an FPGA and/or CPU), one or more memories 604 including computer program code 605, the computer program code 605 having instructions to carry out the methods described herein, wherein the at least one memory 604 and the computer program code 605 are configured to, with the at least one processor 602, cause the apparatus 600 to implement circuitry, a process, component, module, or function (implemented with control module 606) to implement the examples described herein, including an enhanced CSI framework. The memory 604 may be a non-transitory memory, a transitory memory, a volatile memory (e.g. RAM), or a non-volatile memory (e.g. ROM). CSI reporting 630 of the control module implements the herein described aspects related to an enhanced CSI reporting framework.

The apparatus 600 includes a display and/or I/O interface 608, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 600 includes one or more communication e.g. network (N/W) interfaces (I/F(s)) 610. The communication I/F(s) 610 may be wired and/or wireless and communicate over the Internet/other network(s) via any communication technique including via one or more links 624. The link(s) 624 may be the link(s) 11 and/or 79 and/or 31 and/or 81 from FIG. 5. The link(s) 11 and/or 79 and/or 31 and/or 81 from FIG. 5 may also be implemented using transceiver(s) 616 and corresponding wireless link(s) 626. The communication I/F(s) 610 may comprise one or more transmitters or one or more receivers.

The transceiver 616 comprises one or more transmitters 618 and one or more receivers 620. The transceiver 616 and/or communication I/F(s) 610 may comprise standard well-known components such as an amplifier, filter, frequency-converter, (de) modulator, and encoder/decoder circuitries and one or more antennas, such as antennas 614 used for communication over wireless link 626.

The control module 606 of the apparatus 600 comprises one of or both parts 606-1 and/or 606-2, which may be implemented in a number of ways. The control module 606 may be implemented in hardware as control module 606-1, such as being implemented as part of the one or more processors 602. The control module 606-1 may be implemented also as an integrated circuit or through other hardware such as a programmable gate array. In another example, the control module 606 may be implemented as control module 606-2, which is implemented as computer program code (having corresponding instructions) 605 and is executed by the one or more processors 602. For instance, the one or more memories 604 store instructions that, when executed by the one or more processors 602, cause the apparatus 600 to perform one or more of the operations as described herein. Furthermore, the one or more processors 602, the one or more memories 604, and example algorithms (e.g., as flowcharts and/or signaling diagrams), encoded as instructions, programs, or code, are means for causing performance of the operations described herein.

The apparatus 600 to implement the functionality of control 606 may be UE 10, base station 70 (e.g. gNB 70), or core network 90 including any of the network functions 99, which network functions 99 may be implemented with a network entity. Thus, processor 602 may correspond to processor(s) 13, processor(s) 73 and/or processor(s) 93, memory 604 may correspond to one or more memories 15, one or more memories 75 and/or one or more memories 95, computer program code 605 may correspond to program 12, program 72, or program 92, communication I/F(s) 610 and/or transceiver 616 may correspond to other circuitry 16, other circuitry 76, or other circuitry 96, and antennas 614 may correspond to antennas 28 or antennas 58.

Alternatively, apparatus 600 and its elements may not correspond to either of UE 10, base station 70, or core network and their respective elements, as apparatus 600 may be part of a self-organizing/optimizing network (SON) node or other node, such as a node in a cloud.

The apparatus 600 may also be distributed throughout the network (e.g. 91) including within and between apparatus 600 and any network element (such as core network 90 and/or the base station 70 and/or the UE 10).

Interface 612 enables data communication and signaling between the various items of apparatus 600, as shown in FIG. 6. For example, the interface 612 may be one or more buses such as address, data, or control buses, and may include any interconnection mechanism, such as a series of lines on a motherboard or integrated circuit, fiber optics or other optical communication equipment, and the like. Computer program code (e.g. instructions) 605, including control 606 may comprise object-oriented software configured to pass data or messages between objects within computer program code 605. The apparatus 600 need not comprise each of the features mentioned, or may comprise other features as well. The various components of apparatus 600 may at least partially reside in a common housing 628, or a subset of the various components of apparatus 600 may at least partially be located in different housings, which different housings may include housing 628.

FIG. 7 shows a schematic representation of non-volatile memory media 700a (e.g. computer/compact disc (CD) or digital versatile disc (DVD)) and 700b (e.g. universal serial bus (USB) memory stick) and 700c (e.g. cloud storage for downloading instructions and/or parameters 702 or receiving emailed instructions and/or parameters 702) storing instructions and/or parameters 702 which when executed by a processor allows the processor to perform one or more of the steps of the methods described herein.

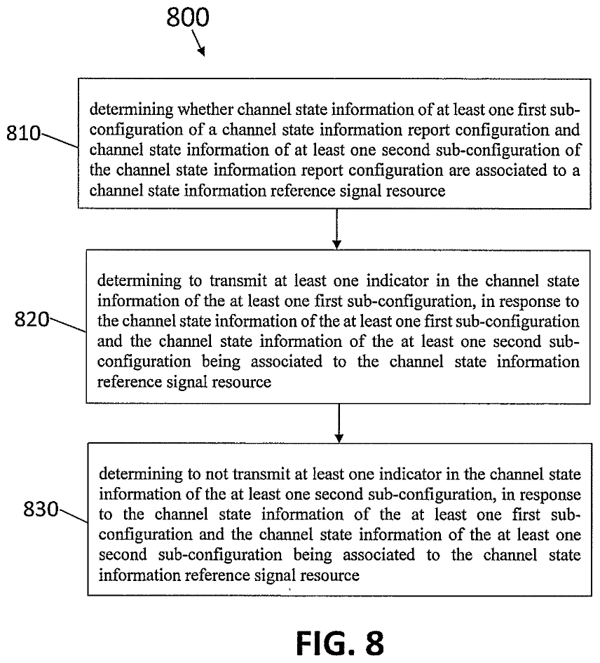

FIG. 8 is an example method 800, based on the example embodiments described herein. At 810, the method includes determining whether channel state information of at least one first sub-configuration of a channel state information report configuration and channel state information of at least one second sub-configuration of the channel state information report configuration are associated to a channel state information reference signal resource. At 820, the method includes determining to transmit at least one indicator in the channel state information of the at least one first sub-configuration, in response to the channel state information of the at least one first sub-configuration and the channel state information of the at least one second sub-configuration being associated to the channel state information reference signal resource. At 830, the method includes determining to not transmit at least one indicator in the channel state information of the at least one second sub-configuration, in response to the channel state information of the at least one first sub-configuration and the channel state information of the at least one second sub-configuration being associated to the channel state information reference signal resource. Method 800 may be performed by UE 10 or apparatus 600.

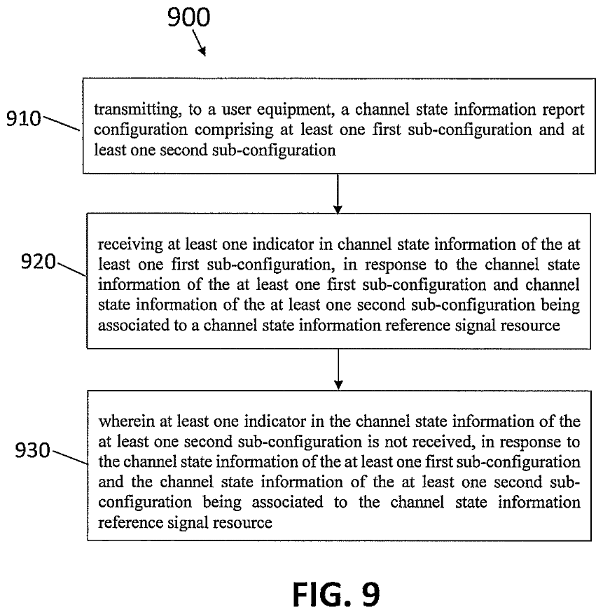

FIG. 9 is an example method 900, based on the example embodiments described herein. At 910, the method includes transmitting, to a user equipment, a channel state information report configuration comprising at least one first sub-configuration and at least one second sub-configuration. At 920, the method includes receiving at least one indicator in channel state information of the at least one first sub-configuration, in response to the channel state information of the at least one first sub-configuration and channel state information of the at least one second sub-configuration being associated to a channel state information reference signal resource. At 930, the method includes wherein at least one indicator in the channel state information of the at least one second sub-configuration is not received, in response to the channel state information of the at least one first sub-configuration and the channel state information of the at least one second sub-configuration being associated to the channel state information reference signal resource. Method 900 may be performed by network node 70, a network function 99 of the core network 90, or apparatus 600.

The following examples are provided and described herein.
Example 1. An apparatus including: at least one processor; and at least one memory storing instructions that, when executed by the at least one processor, cause the apparatus at least to: determine whether channel state information of at least one first sub-configuration of a channel state information report configuration and channel state information of at least one second sub-configuration of the channel state information report configuration are associated to a channel state information reference signal resource; determine to transmit at least one indicator in the channel state information of the at least one first sub-configuration, in response to the channel state information of the at least one first sub-configuration and the channel state information of the at least one second sub-configuration being associated to the channel state information reference signal resource; and determine to not transmit at least one indicator in the channel state information of the at least one second sub-configuration, in response to the channel state information of the at least one first sub-configuration and the channel state information of the at least one second sub-configuration being associated to the channel state information reference signal resource.
Example 2. The apparatus of example 1, wherein: the at least one indicator in the channel state information of the at least one first sub-configuration comprises a precoding matrix indicator; and the at least one indicator in the channel state information of the at least one second sub-configuration comprises a precoding matrix indicator.
Example 3. The apparatus of any of examples 1 to 2, wherein: the at least one indicator in the channel state information of the at least one first sub-configuration comprises a layer indicator; and the at least one indicator in the channel state information of the at least one second sub-configuration comprises a layer indicator.
Example 4. The apparatus of any of examples 1 to 3, wherein the channel state information of the at least one first sub-configuration and the channel state information of the at least one second sub-configuration are associated to the channel state information reference signal resource based on the channel state information report configuration.
Example 5. The apparatus of any of examples 1 to 4, wherein the instructions, when executed by the at least one processor, cause the apparatus at least to: select at least one channel state information reference signal resource indicator; and determine the channel state information of the at least one first sub-configuration and the channel state information of the at least one second sub-configuration to be associated to the channel state information reference signal resource, based on the selected at least one channel state information reference signal resource indicator.
Example 6. The apparatus of any of examples 1 to 5, wherein the instructions, when executed by the at least one processor, cause the apparatus at least to determine the channel state information of the at least one first sub-configuration and the channel state information of the at least one second sub-configuration to be associated to the channel state information reference signal resource in response to at least one of: a channel state information reference signal resource for the at least one first sub-configuration being linked to a channel state information reference signal resource for the at least one second sub-configuration, or a channel state information reference signal resource for the at least one first sub-configuration being linked to a channel state information reference signal resource for the at least one second sub-configuration, wherein at least one or a selected channel state information reference signal resource indicator for the channel state information of the at least one first sub-configuration points to the channel state information reference signal resource for the at least one first sub-configuration, and at least one or a selected channel state information reference signal resource indicator for the channel state information of the at least one second sub-configuration points to the channel state information reference signal resource for the at least one second sub-configuration, or a selected channel state information reference signal resource indicator for the channel state information of the at least one first sub-configuration being the same as a selected channel state information reference signal resource indicator for the channel state information of the at least one second sub-configuration.
Example 7. The apparatus of any of examples 1 to 6, wherein the instructions, when executed by the at least one processor, cause the apparatus at least to: determine to transmit the at least one indicator in the channel state information of the at least one first sub-configuration, in response to an index of the at least one first sub-configuration being higher or lower than an index of the at least one second sub-configuration; and determine to not transmit the at least one indicator in the channel state information of the at least one second sub-configuration, in response to the index of the at least one second sub-configuration being lower or higher than the index of the at least one first sub-configuration.
Example 8. The apparatus of example 7, wherein the index of the at least one first sub-configuration and the index of the at least one second sub-configuration correspond to respective positions of the at least one first sub-configuration and the at least one second sub-configuration within the channel state information report configuration.
Example 9. The apparatus of any of examples 1 to 8, wherein the instructions, when executed by the at least one processor, cause the apparatus at least to: determine to transmit the at least one indicator in the channel state information of the at least one first sub-configuration, in response to a rank indicator of the at least one first sub-configuration being higher than a rank indicator of the at least one second sub-configuration; and determine to not transmit the at least one indicator in the channel state information of the at least one second sub-configuration, in response to the rank indicator of the at least one first sub-configuration being higher than the rank indicator of the at least one second sub-configuration.
Example 10. The apparatus of any of examples 1 to 9, wherein: the at least one indicator in the channel state information of the at least one first sub-configuration comprises a wideband precoding matrix indicator; and the at least one indicator in the channel state information of the at least one second sub-configuration comprises a wideband precoding matrix indicator.
Example 11. The apparatus of example 10, wherein a rank indicator of the at least one first sub-configuration is different from a rank indicator of the at least one second sub-configuration.
Example 12. The apparatus of any of examples 1 to 11, wherein the instructions, when executed by the at least one processor, cause the apparatus at least to: transmit the channel state information of the at least one first sub-configuration and the channel state information of the at least one second sub-configuration within a channel state information report, based on the channel state information report configuration.
Example 13. The apparatus of any of examples 1 to 12, wherein one or more of the following applies to the at least one first sub-configuration and the at least one second sub-configuration: the at least one first sub-configuration and the at least one second sub-configuration share a same parameter, or the at least one first sub-configuration and the at least one second sub-configuration correspond to a same domain adaptation, or the at least one first sub-configuration and the at least one second sub-configuration do not comprise a parameter, or the at least one first sub-configuration and the at least one second sub-configuration have a special configuration element or belong to a group of sub-configurations.
Example 14. The apparatus of any of examples 1 to 13, wherein the at least one first sub-configuration comprises a first plurality of sub-configurations, or the at least one second sub-configuration comprises a second plurality of sub-configurations.
Example 15. The apparatus of example 14, wherein the instructions, when executed by the at least one processor, cause the apparatus at least to: determine whether the channel state information at least one sub-configuration of the first plurality of sub-configurations and the channel state information of at least one sub-configuration of the second plurality of sub-configurations are associated to the channel state information reference signal resource; and perform at least one of: determine to transmit at least one indicator in the channel state information of a respective at least one of the first plurality of sub-configurations, and determine to not transmit a plurality of respective indicators in the channel state information of the second plurality of sub-configurations, in response to the channel state information of the at least one sub-configuration of the first plurality of sub-configurations and the channel state information of the at least one sub-configuration of the second plurality of sub-configurations being associated to the channel state information reference signal resource, or determine to transmit a plurality of respective indicators in the channel state information of the first plurality of sub-configurations, and determine to not transmit at least one indicator in the channel state information of a respective at least one of the second plurality of sub-configurations, in response to the channel state information of the at least one sub-configuration of the first plurality of sub-configurations and the channel state information of the at least one sub-configuration of the second plurality of sub-configurations being associated to the channel state information reference signal resource.
Example 16. The apparatus of any of examples 1 to 15, wherein the instructions, when executed by the at least one processor, cause the apparatus at least to: determine to transmit the at least one indicator in the channel state information of the at least one first sub-configuration, in response to the channel state information of the at least one first sub-configuration and the channel state information of the at least one second sub-configuration being associated to a same or linked channel state information reference signal resource; and determine to not transmit an indicator in the channel state information of the at least one second sub-configuration, in response to the channel state information of the at least one first sub-configuration and the channel state information of the at least one second sub-configuration being associated to the same or linked channel state information reference signal resource.
Example 17. The apparatus of any of examples 1 to 16, wherein a rank indicator of the at least one first sub-configuration is the same as a rank indicator of the at least one second sub-configuration.
Example 18. An apparatus including: at least one processor; and at least one memory storing instructions that, when executed by the at least one processor, cause the apparatus at least to: transmit, to a user equipment, a channel state information report configuration comprising at least one first sub-configuration and at least one second sub-configuration; receive at least one indicator in channel state information of the at least one first sub-configuration, in response to the channel state information of the at least one first sub-configuration and channel state information of the at least one second sub-configuration being associated to a channel state information reference signal resource; and wherein at least one indicator in the channel state information of the at least one second sub-configuration is not received, in response to the channel state information of the at least one first sub-configuration and the channel state information of the at least one second sub-configuration being associated to the channel state information reference signal resource.
Example 19. The apparatus of example 18, wherein: the at least one indicator in the channel state information of the at least one first sub-configuration comprises a precoding matrix indicator; and the at least one indicator in the channel state information of the at least one second sub-configuration comprises a precoding matrix indicator.
Example 20. The apparatus of any of examples 18 to 19, wherein: the at least one indicator in the channel state information of the at least one first sub-configuration comprises a layer indicator; and the at least one indicator in the channel state information of the at least one second sub-configuration comprises a layer indicator.
Example 21. The apparatus of any of examples 18 to 20, wherein the channel state information of the at least one first sub-configuration and the channel state information of the at least one second sub-configuration are associated to the channel state information reference signal resource based on the channel state information report configuration.
Example 22. The apparatus of any of examples 18 to 21, wherein the channel state information of the at least one first sub-configuration and the channel state information of the at least one second sub-configuration are associated to the channel state information reference signal resource based on a selected at least one channel state information reference signal resource indicator.
Example 23. The apparatus of any of examples 18 to 22, wherein the channel state information of the at least one first sub-configuration and the channel state information of the at least one second sub-configuration are associated to the channel state information reference signal resource based on at least one of: a channel state information reference signal resource for the at least one first sub-configuration being linked to a channel state information reference signal resource for the at least one second sub-configuration, or a channel state information reference signal resource for the at least one first sub-configuration being linked to a channel state information reference signal resource for the at least one second sub-configuration, wherein at least one or a selected channel state information reference signal resource indicator for the channel state information of the at least one first sub-configuration points to the channel state information reference signal resource for the at least one first sub-configuration, and at least one or a selected channel state information reference signal resource indicator for the channel state information of the at least one second sub-configuration points to the channel state information reference signal resource for the at least one second sub-configuration, or a selected channel state information reference signal resource indicator for the channel state information of the at least one first sub-configuration being the same as a selected channel state information reference signal resource indicator for the channel state information of the at least one second sub-configuration.
Example 24. The apparatus of any of examples 18 to 23, wherein the instructions, when executed by the at least one processor, cause the apparatus at least to: receive the at least one indicator in the channel state information of the at least one first sub-configuration, in response to an index of the at least one first sub-configuration being higher or lower than an index of the at least one second sub-configuration; wherein the at least one indicator in the channel state information of the at least one second sub-configuration is not received, in response to the index of the at least one second sub-configuration being lower or higher than the index of the at least one first sub-configuration.
Example 25. The apparatus of example 24, wherein the index of the at least one first sub-configuration and the index of the at least one second sub-configuration correspond to respective positions of the at least one first sub-configuration and the at least one second sub-configuration within the channel state information report configuration.
Example 26. The apparatus of any of examples 18 to 25, wherein the instructions, when executed by the at least one processor, cause the apparatus at least to: receive the at least one indicator in the channel state information of the at least one first sub-configuration, in response to a rank indicator of the at least one first sub-configuration being higher than a rank indicator of the at least one second sub-configuration; wherein the at least one indicator in the channel state information of the at least one second sub-configuration is not received, in response to the rank indicator of the at least one first sub-configuration being higher than the rank indicator of the at least one second sub-configuration.
Example 27. The apparatus of any of examples 18 to 26, wherein: the at least one indicator in the channel state information of the at least one first sub-configuration comprises a wideband precoding matrix indicator; and the at least one indicator in the channel state information of the at least one second sub-configuration comprises a wideband precoding matrix indicator.
Example 28. The apparatus of example 27, wherein a rank indicator of the at least one first sub-configuration is different from a rank indicator of the at least one second sub-configuration.
Example 29. The apparatus of any of examples 18 to 28, wherein the instructions, when executed by the at least one processor, cause the apparatus at least to: receive the channel state information of the at least one first sub-configuration and the channel state information of the at least one second sub-configuration within a channel state information report, based on the channel state information report configuration.
Example 30. The apparatus of any of examples 18 to 29, wherein one or more of the following applies to the at least one first sub-configuration and the at least one second sub-configuration: the at least one first sub-configuration and the at least one second sub-configuration share a same parameter, or the at least one first sub-configuration and the at least one second sub-configuration correspond to a same domain adaptation, or the at least one first sub-configuration and the at least one second sub-configuration do not comprise a parameter, or the at least one first sub-configuration and the at least one second sub-configuration have a special configuration element or belong to a group of sub-configurations.
Example 31. The apparatus of any of examples 18 to 30, wherein the at least one first sub-configuration comprises a first plurality of sub-configurations, or the at least one second sub-configuration comprises a second plurality of sub-configurations.
Example 32. The apparatus of example 31, wherein the instructions, when executed by the at least one processor, cause the apparatus at least to perform at least one of: receive at least one indicator in the channel state information of a respective at least one of the first plurality of sub-configurations, wherein a plurality of respective indicators in the channel state information of the second plurality of sub-configurations, are not received, in response to the channel state information of at least one sub-configuration of the first plurality of sub-configurations and the channel state information of at least one sub-configuration of the second plurality of sub-configurations being associated to the channel state information reference signal resource, or receive plurality of respective indicators in the channel state information of the first plurality of sub-configurations, wherein at least one indicator in the channel state information of a respective at least one of the second plurality of sub-configurations are not received, in response to the channel state information of at least one sub-configuration of the first plurality of sub-configurations and the channel state information of at least one sub-configuration of the second plurality of sub-configurations being associated to the channel state information reference signal resource.
Example 33. The apparatus of any of examples 18 to 32, wherein the instructions, when executed by the at least one processor, cause the apparatus at least to: receive the at least one indicator in the channel state information of the at least one first sub-configuration, in response to the channel state information of the at least one first sub-configuration and the channel state information of the at least one second sub-configuration being associated to a same or linked channel state information reference signal resource; wherein the at least one indicator in the channel state information of the at least one second sub-configuration is not received, in response to the channel state information of the at least one first sub-configuration and the channel state information of the at least one second sub-configuration being associated to the same or linked channel state information reference signal resource.
Example 34. The apparatus of any of examples 18 to 33, wherein a rank indicator of the at least one first sub-configuration is the same as a rank indicator of the at least one second sub-configuration.
Example 35. An apparatus including: means for determining whether channel state information of at least one first sub-configuration of a channel state information report configuration and channel state information of at least one second sub-configuration of the channel state information report configuration are associated to a channel state information reference signal resource; means for determining to transmit at least one indicator in the channel state information of the at least one first sub-configuration, in response to the channel state information of the at least one first sub-configuration and the channel state information of the at least one second sub-configuration being associated to the channel state information reference signal resource; and means for determining to not transmit at least one indicator in the channel state information of the at least one second sub-configuration, in response to the channel state information of the at least one first sub-configuration and the channel state information of the at least one second sub-configuration being associated to the channel state information reference signal resource.
Example 36. An apparatus including: means for transmitting, to a user equipment, a channel state information report configuration comprising at least one first sub-configuration and at least one second sub-configuration; means for receiving at least one indicator in channel state information of the at least one first sub-configuration, in response to the channel state information of the at least one first sub-configuration and channel state information of the at least one second sub-configuration being associated to a channel state information reference signal resource; and wherein at least one indicator in the channel state information of the at least one second sub-configuration is not received, in response to the channel state information of the at least one first sub-configuration and the channel state information of the at least one second sub-configuration being associated to the channel state information reference signal resource.
Example 37. A non-transitory program storage device readable by a machine, tangibly embodying a program of instructions executable by the machine for performing operations, the operations including: determining whether channel state information of at least one first sub-configuration of a channel state information report configuration and channel state information of at least one second sub-configuration of the channel state information report configuration are associated to a channel state information reference signal resource; determining to transmit at least one indicator in the channel state information of the at least one first sub-configuration, in response to the channel state information of the at least one first sub-configuration and the channel state information of the at least one second sub-configuration being associated to the channel state information reference signal resource; and determining to not transmit at least one indicator in the channel state information of the at least one second sub-configuration, in response to the channel state information of the at least one first sub-configuration and the channel state information of the at least one second sub-configuration being associated to the channel state information reference signal resource.
Example 38. A non-transitory program storage device readable by a machine, tangibly embodying a program of instructions executable by the machine for performing operations, the operations including: transmitting, to a user equipment, a channel state information report configuration comprising at least one first sub-configuration and at least one second sub-configuration; receiving at least one indicator in channel state information of the at least one first sub-configuration, in response to the channel state information of the at least one first sub-configuration and channel state information of the at least one second sub-configuration being associated to a channel state information reference signal resource; and wherein at least one indicator in the channel state information of the at least one second sub-configuration is not received, in response to the channel state information of the at least one first sub-configuration and the channel state information of the at least one second sub-configuration being associated to the channel state information reference signal resource.
Example 39. A method including: determining whether channel state information of at least one first sub-configuration of a channel state information report configuration and channel state information of at least one second sub-configuration of the channel state information report configuration are associated to a channel state information reference signal resource; determining to transmit at least one indicator in the channel state information of the at least one first sub-configuration, in response to the channel state information of the at least one first sub-configuration and the channel state information of the at least one second sub-configuration being associated to the channel state information reference signal resource; and determining to not transmit at least one indicator in the channel state information of the at least one second sub-configuration, in response to the channel state information of the at least one first sub-configuration and the channel state information of the at least one second sub-configuration being associated to the channel state information reference signal resource.
Example 40. The method of example 39, wherein: the at least one indicator in the channel state information of the at least one first sub-configuration comprises a precoding matrix indicator; and the at least one indicator in the channel state information of the at least one second sub-configuration comprises a precoding matrix indicator.
Example 41. The method of any of examples 39 to 40, wherein: the at least one indicator in the channel state information of the at least one first sub-configuration comprises a layer indicator; and the at least one indicator in the channel state information of the at least one second sub-configuration comprises a layer indicator.
Example 42. The method of any of examples 39 to 41, wherein the channel state information of the at least one first sub-configuration and the channel state information of the at least one second sub-configuration are associated to the channel state information reference signal resource based on the channel state information report configuration.
Example 43. The method of any of examples 39 to 42, further including: selecting at least one channel state information reference signal resource indicator; and determining the channel state information of the at least one first sub-configuration and the channel state information of the at least one second sub-configuration to be associated to the channel state information reference signal resource, based on the selected at least one channel state information reference signal resource indicator.
Example 44. The method of any of examples 39 to 43, further including determining the channel state information of the at least one first sub-configuration and the channel state information of the at least one second sub-configuration to be associated to the channel state information reference signal resource in response to at least one of: a channel state information reference signal resource for the at least one first sub-configuration being linked to a channel state information reference signal resource for the at least one second sub-configuration, or a channel state information reference signal resource for the at least one first sub-configuration being linked to a channel state information reference signal resource for the at least one second sub-configuration, wherein at least one or a selected channel state information reference signal resource indicator for the channel state information of the at least one first sub-configuration points to the channel state information reference signal resource for the at least one first sub-configuration, and at least one or a selected channel state information reference signal resource indicator for the channel state information of the at least one second sub-configuration points to the channel state information reference signal resource for the at least one second sub-configuration, or a selected channel state information reference signal resource indicator for the channel state information of the at least one first sub-configuration being the same as a selected channel state information reference signal resource indicator for the channel state information of the at least one second sub-configuration.
Example 45. The method of any of examples 39 to 44, further including: determining to transmit the at least one indicator in the channel state information of the at least one first sub-configuration, in response to an index of the at least one first sub-configuration being higher or lower than an index of the at least one second sub-configuration; and determining to not transmit the at least one indicator in the channel state information of the at least one second sub-configuration, in response to the index of the at least one second sub-configuration being lower or higher than the index of the at least one first sub-configuration.
Example 46. The method of example 45, wherein the index of the at least one first sub-configuration and the index of the at least one second sub-configuration correspond to respective positions of the at least one first sub-configuration and the at least one second sub-configuration within the channel state information report configuration.
Example 47. The method of any of examples 39 to 46, further including: determining to transmit the at least one indicator in the channel state information of the at least one first sub-configuration, in response to a rank indicator of the at least one first sub-configuration being higher than a rank indicator of the at least one second sub-configuration; and determining to not transmit the at least one indicator in the channel state information of the at least one second sub-configuration, in response to the rank indicator of the at least one first sub-configuration being higher than the rank indicator of the at least one second sub-configuration.
Example 48. The method of any of examples 39 to 47, wherein: the at least one indicator in the channel state information of the at least one first sub-configuration comprises a wideband precoding matrix indicator; and the at least one indicator in the channel state information of the at least one second sub-configuration comprises a wideband precoding matrix indicator.
Example 49. The method of example 48, wherein a rank indicator of the at least one first sub-configuration is different from a rank indicator of the at least one second sub-configuration.
Example 50. The method of any of examples 39 to 49, further including: transmitting the channel state information of the at least one first sub-configuration and the channel state information of the at least one second sub-configuration within a channel state information report, based on the channel state information report configuration.
Example 51. The method of any of examples 39 to 50, wherein one or more of the following applies to the at least one first sub-configuration and the at least one second sub-configuration: the at least one first sub-configuration and the at least one second sub-configuration share a same parameter, or the at least one first sub-configuration and the at least one second sub-configuration correspond to a same domain adaptation, or the at least one first sub-configuration and the at least one second sub-configuration do not comprise a parameter, or the at least one first sub-configuration and the at least one second sub-configuration have a special configuration element or belong to a group of sub-configurations.
Example 52. The method of any of examples 39 to 51, wherein the at least one first sub-configuration comprises a first plurality of sub-configurations, or the at least one second sub-configuration comprises a second plurality of sub-configurations.
Example 53. The method of example 52, further including: determining whether the channel state information at least one sub-configuration of the first plurality of sub-configurations and the channel state information of at least one sub-configuration of the second plurality of sub-configurations are associated to the channel state information reference signal resource; and performing at least one of: determining to transmit at least one indicator in the channel state information of a respective at least one of the first plurality of sub-configurations, and determining to not transmit a plurality of respective indicators in the channel state information of the second plurality of sub-configurations, in response to the channel state information of the at least one sub-configuration of the first plurality of sub-configurations and the channel state information of the at least one sub-configuration of the second plurality of sub-configurations being associated to the channel state information reference signal resource, or determining to transmit a plurality of respective indicators in the channel state information of the first plurality of sub-configurations, and determining to not transmit at least one indicator in the channel state information of a respective at least one of the second plurality of sub-configurations, in response to the channel state information of the at least one sub-configuration of the first plurality of sub-configurations and the channel state information of the at least one sub-configuration of the second plurality of sub-configurations being associated to the channel state information reference signal resource.
Example 54. The method of any of examples 39 to 53, further including: determining to transmit the at least one indicator in the channel state information of the at least one first sub-configuration, in response to the channel state information of the at least one first sub-configuration and the channel state information of the at least one second sub-configuration being associated to a same or linked channel state information reference signal resource; and determining to not transmit an indicator in the channel state information of the at least one second sub-configuration, in response to the channel state information of the at least one first sub-configuration and the channel state information of the at least one second sub-configuration being associated to the same or linked channel state information reference signal resource.
Example 55. The method of any of examples 39 to 54, wherein a rank indicator of the at least one first sub-configuration is the same as a rank indicator of the at least one second sub-configuration.
Example 56. A method including: transmitting, to a user equipment, a channel state information report configuration comprising at least one first sub-configuration and at least one second sub-configuration; receiving at least one indicator in channel state information of the at least one first sub-configuration, in response to the channel state information of the at least one first sub-configuration and channel state information of the at least one second sub-configuration being associated to a channel state information reference signal resource; and wherein at least one indicator in the channel state information of the at least one second sub-configuration is not received, in response to the channel state information of the at least one first sub-configuration and the channel state information of the at least one second sub-configuration being associated to the channel state information reference signal resource.
Example 57. The method of example 56, wherein: the at least one indicator in the channel state information of the at least one first sub-configuration comprises a precoding matrix indicator; and the at least one indicator in the channel state information of the at least one second sub-configuration comprises a precoding matrix indicator.
Example 58. The method of any of examples 56 to 57, wherein: the at least one indicator in the channel state information of the at least one first sub-configuration comprises a layer indicator; and the at least one indicator in the channel state information of the at least one second sub-configuration comprises a layer indicator.
Example 59. The method of any of examples 56 to 58, wherein the channel state information of the at least one first sub-configuration and the channel state information of the at least one second sub-configuration are associated to the channel state information reference signal resource based on the channel state information report configuration.
Example 60. The method of any of examples 56 to 59, wherein the channel state information of the at least one first sub-configuration and the channel state information of the at least one second sub-configuration are associated to the channel state information reference signal resource based on a selected at least one channel state information reference signal resource indicator.
Example 61. The method of any of examples 56 to 60, wherein the channel state information of the at least one first sub-configuration and the channel state information of the at least one second sub-configuration are associated to the channel state information reference signal resource based on at least one of: a channel state information reference signal resource for the at least one first sub-configuration being linked to a channel state information reference signal resource for the at least one second sub-configuration, or a channel state information reference signal resource for the at least one first sub-configuration being linked to a channel state information reference signal resource for the at least one second sub-configuration, wherein at least one or a selected channel state information reference signal resource indicator for the channel state information of the at least one first sub-configuration points to the channel state information reference signal resource for the at least one first sub-configuration, and at least one or a selected channel state information reference signal resource indicator for the channel state information of the at least one second sub-configuration points to the channel state information reference signal resource for the at least one second sub-configuration, or a selected channel state information reference signal resource indicator for the channel state information of the at least one first sub-configuration being the same as a selected channel state information reference signal resource indicator for the channel state information of the at least one second sub-configuration.
Example 62. The method of any of examples 56 to 61, further including: receiving the at least one indicator in the channel state information of the at least one first sub-configuration, in response to an index of the at least one first sub-configuration being higher or lower than an index of the at least one second sub-configuration; wherein the at least one indicator in the channel state information of the at least one second sub-configuration is not received, in response to the index of the at least one second sub-configuration being lower or higher than the index of the at least one first sub-configuration.
Example 63. The method of example 62, wherein the index of the at least one first sub-configuration and the index of the at least one second sub-configuration correspond to respective positions of the at least one first sub-configuration and the at least one second sub-configuration within the channel state information report configuration.
Example 64. The method of any of examples 56 to 63, further including: receiving the at least one indicator in the channel state information of the at least one first sub-configuration, in response to a rank indicator of the at least one first sub-configuration being higher than a rank indicator of the at least one second sub-configuration; wherein the at least one indicator in the channel state information of the at least one second sub-configuration is not received, in response to the rank indicator of the at least one first sub-configuration being higher than the rank indicator of the at least one second sub-configuration.
Example 65. The method of any of examples 56 to 64, wherein: the at least one indicator in the channel state information of the at least one first sub-configuration comprises a wideband precoding matrix indicator; and the at least one indicator in the channel state information of the at least one second sub-configuration comprises a wideband precoding matrix indicator.
Example 66. The method of example 65, wherein a rank indicator of the at least one first sub-configuration is different from a rank indicator of the at least one second sub-configuration.
Example 67. The method of any of examples 56 to 66, further including: receiving the channel state information of the at least one first sub-configuration and the channel state information of the at least one second sub-configuration within a channel state information report, based on the channel state information report configuration.
Example 68. The method of any of examples 56 to 67, wherein one or more of the following applies to the at least one first sub-configuration and the at least one second sub-configuration: the at least one first sub-configuration and the at least one second sub-configuration share a same parameter, or the at least one first sub-configuration and the at least one second sub-configuration correspond to a same domain adaptation, or the at least one first sub-configuration and the at least one second sub-configuration do not comprise a parameter, or the at least one first sub-configuration and the at least one second sub-configuration have a special configuration element or belong to a group of sub-configurations.
Example 69. The method of any of examples 56 to 68, wherein the at least one first sub-configuration comprises a first plurality of sub-configurations, or the at least one second sub-configuration comprises a second plurality of sub-configurations.
Example 70. The method of example 69, further including performing at least one of: receiving at least one indicator in the channel state information of a respective at least one of the first plurality of sub-configurations, wherein a plurality of respective indicators in the channel state information of the second plurality of sub-configurations, are not received, in response to the channel state information of at least one sub-configuration of the first plurality of sub-configurations and the channel state information of at least one sub-configuration of the second plurality of sub-configurations being associated to the channel state information reference signal resource, or receiving plurality of respective indicators in the channel state information of the first plurality of sub-configurations, wherein at least one indicator in the channel state information of a respective at least one of the second plurality of sub-configurations are not received, in response to the channel state information of at least one sub-configuration of the first plurality of sub-configurations and the channel state information of at least one sub-configuration of the second plurality of sub-configurations being associated to the channel state information reference signal resource.
Example 71. The method of any of examples 56 to 70, further including: receiving the at least one indicator in the channel state information of the at least one first sub-configuration, in response to the channel state information of the at least one first sub-configuration and the channel state information of the at least one second sub-configuration being associated to a same or linked channel state information reference signal resource; wherein the at least one indicator in the channel state information of the at least one second sub-configuration is not received, in response to the channel state information of the at least one first sub-configuration and the channel state information of the at least one second sub-configuration being associated to the same or linked channel state information reference signal resource.
Example 72. The method of any of examples 56 to 71, wherein a rank indicator of the at least one first sub-configuration is the same as a rank indicator of the at least one second sub-configuration.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):
3GPP third generation partnership project
4G fourth generation
5G fifth generation
5GC 5G core network
A-CSI aperiodic channel state information
AAU active antenna unit
AMF access and mobility management function
ASIC application-specific integrated circuit
BM beam management
BWP bandwidth part
CC component carrier
CD compact/computer disc
CE control element
CPU central processing unit
CRI CSI-RS resource indicator
CQI channel quality indicator
CSI channel state information
CSI-RS channel state information reference signal
DCI downlink control information
DL downlink
DSP digital signal processor
DVD digital versatile disc
eNB evolved Node B (e.g., an LTE base station)
EPC evolved packet core
E-SMLC evolved serving mobile location center
FPGA field-programmable gate array
GMLC gateway mobile location center
gNB next generation node B, base station for 5G/NR, i.e., a node providing NR user plane and control plane protocol terminations towards the UE, and connected via the NG interface to the 5GC
GSMA Global System for Mobile Communications Association
I/F interface
I/O input/output
L1 layer 1
LI layer indicator
LMF location management function
LTE long term evolution (4G)
MAC medium access control
MIMO multiple input multiple output
MME mobility management entity
NF network function
NG new generation
NG-RAN new generation radio access network
nrofPorts number of ports
NR new radio
NRF network repository function
N/W network
NZP non-zero-power
OFDM orthogonal frequency-division multiplexing
OPEX operating expenses
PMI precoding matrix indicator
PUSCH physical uplink shared channel
RAM random access memory
RAN radio access network
RAN1 radio layer 1
RE resource element
Rel release
RI rank indicator
ROM read-only memory
RRC radio resource control
RS reference signal
RSRP reference signal received power
Rx receiver or reception
S1 interface connecting the eNB to the EPC
SB sub-band
SGW serving gateway
SMF session management function
SON self-organizing/optimizing network
SP-CSI semi-persistent channel state information
TRP transmission reception point
TRS tracking reference signal
TS technical specification
Tx transmitter or transmission
UDM unified data management
UDR unified data repository
UE user equipment (e.g., a wireless, typically mobile device)
UI user interface
UL uplink
UPF user plane function
USB universal serial bus
WB wideband
WID working item description
Wi-Fi wireless networking protocol that devices use to communicate without direct cable connections
X2 network interface between RAN nodes and between RAN and the core network
Xn network interface between NG-RAN nodes
XR extended reality or cross reality

What is claimed is:

1. An apparatus comprising:
at least one processor; and
at least one memory storing instructions that, when executed by the at least one processor, cause the apparatus at least to:
determine whether channel state information of at least one first sub-configuration of a channel state information report configuration and channel state information of at least one second sub-configuration of the channel state information report configuration are associated to a channel state information reference signal resource;
determine to transmit at least one indicator in the channel state information of the at least one first sub-configuration, in response to the channel state information of the at least one first sub-configuration and the channel state information of the at least one second sub-configuration being associated to the channel state information reference signal resource; and
determine to not transmit at least one indicator in the channel state information of the at least one second sub-configuration, in response to the channel state information of the at least one first sub-configuration and the channel state information of the at least one second sub-configuration being associated to the channel state information reference signal resource.

2. The apparatus of claim 1, wherein:
the at least one indicator in the channel state information of the at least one first sub-configuration comprises a precoding matrix indicator; and
the at least one indicator in the channel state information of the at least one second sub-configuration comprises a precoding matrix indicator.

3. The apparatus of claim 1, wherein:
the at least one indicator in the channel state information of the at least one first sub-configuration comprises a layer indicator; and
the at least one indicator in the channel state information of the at least one second sub-configuration comprises a layer indicator.

4. The apparatus of claim 1, wherein the channel state information of the at least one first sub-configuration and the channel state information of the at least one second sub-configuration are associated to the channel state information reference signal resource based on the channel state information report configuration.

5. The apparatus of claim 1, wherein the instructions, when executed by the at least one processor, cause the apparatus at least to:
select at least one channel state information reference signal resource indicator; and
determine the channel state information of the at least one first sub-configuration and the channel state information of the at least one second sub-configuration to be associated to the channel state information reference signal resource, based on the selected at least one channel state information reference signal resource indicator.

6. The apparatus of claim 1, wherein the instructions, when executed by the at least one processor, cause the apparatus at least to determine the channel state information of the at least one first sub-configuration and the channel state information of the at least one second sub-configuration to be associated to the channel state information reference signal resource in response to at least one of:
a channel state information reference signal resource for the at least one first sub-configuration being linked to a channel state information reference signal resource for the at least one second sub-configuration, or
a channel state information reference signal resource for the at least one first sub-configuration being linked to a channel state information reference signal resource for the at least one second sub-configuration, wherein at least one or a selected channel state information reference signal resource indicator for the channel state information of the at least one first sub-configuration points to the channel state information reference signal resource for the at least one first sub-configuration, and at least one or a selected channel state information reference signal resource indicator for the channel state information of the at least one second sub-configuration points to the channel state information reference signal resource for the at least one second sub-configuration, or
a selected channel state information reference signal resource indicator for the channel state information of the at least one first sub-configuration being the same as a selected channel state information reference signal resource indicator for the channel state information of the at least one second sub-configuration.

7. The apparatus of claim 1, wherein the instructions, when executed by the at least one processor, cause the apparatus at least to:
determine to transmit the at least one indicator in the channel state information of the at least one first sub-configuration, in response to an index of the at least one first sub-configuration being higher or lower than an index of the at least one second sub-configuration; and
determine to not transmit the at least one indicator in the channel state information of the at least one second sub-configuration, in response to the index of the at least one second sub-configuration being lower or higher than the index of the at least one first sub-configuration.

8. The apparatus of claim 7, wherein the index of the at least one first sub-configuration and the index of the at least one second sub-configuration correspond to respective positions of the at least one first sub-configuration and the at least one second sub-configuration within the channel state information report configuration.

9. The apparatus of claim 1, wherein the instructions, when executed by the at least one processor, cause the apparatus at least to:
determine to transmit the at least one indicator in the channel state information of the at least one first sub-configuration, in response to a rank indicator of the at least one first sub-configuration being higher than a rank indicator of the at least one second sub-configuration; and
determine to not transmit the at least one indicator in the channel state information of the at least one second sub-configuration, in response to the rank indicator of the at least one first sub-configuration being higher than the rank indicator of the at least one second sub-configuration.

10. The apparatus of claim 1, wherein:
the at least one indicator in the channel state information of the at least one first sub-configuration comprises a wideband precoding matrix indicator; and
the at least one indicator in the channel state information of the at least one second sub-configuration comprises a wideband precoding matrix indicator.

11. The apparatus of claim 10, wherein a rank indicator of the at least one first sub-configuration is different from a rank indicator of the at least one second sub-configuration.

12. The apparatus of claim 1, wherein the instructions, when executed by the at least one processor, cause the apparatus at least to:
transmit the channel state information of the at least one first sub-configuration and the channel state information of the at least one second sub-configuration within a channel state information report, based on the channel state information report configuration.

13. The apparatus of claim 1, wherein one or more of the following applies to the at least one first sub-configuration and the at least one second sub-configuration:
the at least one first sub-configuration and the at least one second sub-configuration share a same parameter, or
the at least one first sub-configuration and the at least one second sub-configuration correspond to a same domain adaptation, or
the at least one first sub-configuration and the at least one second sub-configuration do not comprise a parameter, or
the at least one first sub-configuration and the at least one second sub-configuration have a special configuration element or belong to a group of sub-configurations.

14. The apparatus of claim 1, wherein the at least one first sub-configuration comprises a first plurality of sub-configurations, or the at least one second sub-configuration comprises a second plurality of sub-configurations.

15. The apparatus of claim 14, wherein the instructions, when executed by the at least one processor, cause the apparatus at least to:
determine whether the channel state information at least one sub-configuration of the first plurality of sub-configurations and the channel state information of at least one sub-configuration of the second plurality of sub-configurations are associated to the channel state information reference signal resource; and
perform at least one of:
determine to transmit at least one indicator in the channel state information of a respective at least one of the first plurality of sub-configurations, and determine to not transmit a plurality of respective indicators in the channel state information of the second plurality of sub-configurations, in response to the channel state information of the at least one sub-configuration of the first plurality of sub-configurations and the channel state information of the at least one sub-configuration of the second plurality of sub-configurations being associated to the channel state information reference signal resource, or
determine to transmit a plurality of respective indicators in the channel state information of the first plurality of sub-configurations, and determine to not transmit at least one indicator in the channel state information of a respective at least one of the second plurality of sub-configurations, in response to the channel state information of the at least one sub-configuration of the first plurality of sub-configurations and the channel state information of the at least one sub-configuration of the second plurality of sub-configurations being associated to the channel state information reference signal resource.

16. The apparatus of claim 1, wherein the instructions, when executed by the at least one processor, cause the apparatus at least to:
determine to transmit the at least one indicator in the channel state information of the at least one first sub-configuration, in response to the channel state information of the at least one first sub-configuration and the channel state information of the at least one second sub-configuration being associated to a same or linked channel state information reference signal resource; and
determine to not transmit an indicator in the channel state information of the at least one second sub-configuration, in response to the channel state information of the at least one first sub-configuration and the channel state information of the at least one second sub-configuration being associated to the same or linked channel state information reference signal resource.

17. The apparatus of claim 1, wherein a rank indicator of the at least one first sub-configuration is the same as a rank indicator of the at least one second sub-configuration.

18. An apparatus comprising:
at least one processor; and
at least one memory storing instructions that, when executed by the at least one processor, cause the apparatus at least to:
transmit, to a user equipment, a channel state information report configuration comprising at least one first sub-configuration and at least one second sub-configuration;
receive at least one indicator in channel state information of the at least one first sub-configuration, in response to the channel state information of the at least one first sub-configuration and channel state information of the at least one second sub-configuration being associated to a channel state information reference signal resource; and
wherein at least one indicator in the channel state information of the at least one second sub-configuration is not received, in response to the channel state information of the at least one first sub-configuration and the channel state information of the at least one second sub-configuration being associated to the channel state information reference signal resource.

19. The apparatus of claim 18, wherein:
the at least one indicator in the channel state information of the at least one first sub-configuration comprises a precoding matrix indicator; and
the at least one indicator in the channel state information of the at least one second sub-configuration comprises a precoding matrix indicator.

20. A method comprising:
determining whether channel state information of at least one first sub-configuration of a channel state information report configuration and channel state information of at least one second sub-configuration of the channel state information report configuration are associated to a channel state information reference signal resource;
determining to transmit at least one indicator in the channel state information of the at least one first sub-configuration, in response to the channel state information of the at least one first sub-configuration and the channel state information of the at least one second sub-configuration being associated to the channel state information reference signal resource; and
determining to not transmit at least one indicator in the channel state information of the at least one second sub-configuration, in response to the channel state information of the at least one first sub-configuration and the channel state information of the at least one second sub-configuration being associated to the channel state information reference signal resource.
